(19) United States
(12) Patent Application Publication
(10) Pub. No.: US 2026/0370304 A1
(43) Pub. Date: Nov. 19, 2026

(54) Capacity Metric for Multi-Rx Group Based Reporting

(71) Applicant: Apple Inc., Cupertino, CA (US)

(72) Inventors: Konstantinos SARRIGEORGIDIS, Los Gatos, CA (US); Yang TANG, San Jose, CA (US); Xiang CHEN, Palo Alto, CA (US); Manasa RAGHAVAN, Sunnyvale, CA (US); Jie CUI, San Jose, CA (US); Andre JANSSEN, Munich (DE); Rolando E BETTANCOURT ORTEGA, Munich (DE)

(21) Appl. No.: 19/155,421

(22) PCT Filed: Feb. 9, 2024
(86) PCT No.: PCT/US2024/015133

§ 371 Date: Aug. 11, 2025

Related U.S. Application Data
(60) Provisional application No. 63/485,115, filed on Feb. 15, 2023.

(51) Int. Cl. H04B 7/06; H04B 7/10; H04L 5/00; H04W 24/10

(52) U.S. Cl. CPC H04B 7/0696; H04B 7/0626; H04B 7/0632; H04B 7/10; H04L 5/0051; H04W 24/10

(57) ABSTRACT

An apparatus of a base station configured with a transmission and reception point comprising a dual-polarization antenna array, the apparatus configured to generate a first reference signal (RS) and a second RS in a same orthogonal frequency division multiplexing symbol, the first RS being generated with a first precoding and the second RS being generated with a second precoding different from the first precoding such that a first polarization of the first RS is different from a second polarization of the second RS, process a measurement report including measurement values for the first RS, determine that the first polarization resulted in first measurement values better than second measurement values resulting from the second polarization and beamsweep further RS across different OFDM symbols in dependence on the determination that the first polarization resulted in the first measurement values better than the second measurement values resulting from the second polarization.

### BACKGROUND INFORMATION

A user equipment (UE) may establish a communication link to components of at least one of multiple different networks or types of networks. Signaling between the UE and the network may be achieved via beamforming. Beamforming is an antenna technique used to transmit a directional signal which may be referred to as a beam. Digital precoding may be performed on the signal to control the polarization of the beam prior to analog beamforming.

A cell of the network, e.g., a next generation node B (gNB) may be configured with multiple transmission reception points (TRPs) each configured to perform beamforming. To acquire and maintain a beam between the UE and each of the TRPs, beam management techniques may be implemented on both the UE side and the network side. These beam management techniques may include transmit (Tx) beamsweeping by the network cell via one or more transmission and reception points (TRPs) and receive (Rx) beamsweeping by the UE. Various aspects of Tx and Rx beamforming may affect the quality of the radio link and the capacity, e.g., throughput, attainable via the radio link.

### SUMMARY

Some example embodiments are related to an apparatus of a base station configured with at least one transmission and reception point (TRP) with a dual-polarization antenna array, the apparatus having processing circuitry configured to generate at least a first reference signal (RS) and a second RS in a same orthogonal frequency division multiplexing (OFDM) symbol, the first RS being generated with a first precoding and the second RS being generated with a second precoding different from the first precoding such that a first polarization of the first RS is different from a second polarization of the second RS, process a measurement report including measurement values for at least the first RS, determine that the first polarization resulted in first measurement values better than second measurement values resulting from the second polarization and beamsweep further RS across different OFDM symbols in dependence on the determination that the first polarization resulted in the first measurement values better than the second measurement values resulting from the second polarization.

Other example embodiments are related to an apparatus of a base station with at least one transmission and reception point (TRP) comprising a dual-polarization antenna array, the apparatus having processing circuitry configured to generate at least a first reference signal (RS) and a second RS simultaneously in a dual-stream configuration, the first RS being generated with a first precoding and the second RS being generated with a second precoding different from the first precoding such that a first polarization of the first RS is different from a second polarization of the second RS, process a measurement report including measurement values for at least the first RS, determine that the first polarization resulted in first measurement values better than second measurement values resulting from the second polarization and trigger a channel quality indicator (CQI) link adaptation in dependence on the determination that the first polarization resulted in the first measurement values better than the second measurement values resulting from the second polarization.

Still further example embodiments are related to an apparatus of a user equipment (UE) with a dual-polarization antenna array configured to communicate with at least one transmission and reception point (TRP) of a base station, the apparatus having processing circuitry configured to process a plurality of reference signals (RS) from the at least one TRP, estimate a virtualized effective channel for each of the plurality of RS dependent on a digital precoding and transmit analog beamforming weights used by the at least one TRP to transmit the plurality of RS, determine a best analog receive beam based on the virtualized effective channel estimated for each of the plurality of RS, evaluate a capacity metric for each virtualized effective channel and select one or more best beam pairs based on the capacity metric.

### BRIEF DESCRIPTION OF THE DRAWINGS

FIG. 1a shows a system model for single TRP, single UE panel beamforming according to various exemplary embodiments.

FIG. 1b shows a dual-polarized antenna array according to various exemplary embodiments.

FIG. 2a shows a transmitter model for single TRP, single stream beamforming with a dual-polarization antenna array according to various exemplary embodiments.

FIG. 2b shows a method for single TRP, single stream beam management with a dual-polarization antenna array according to various exemplary embodiments.

FIG. 3 shows a transmitter model for single TRP, dual-stream beamforming according to various exemplary embodiments.

FIG. 4a shows a transmitter model for dual TRP, dual-stream beamforming according to various exemplary embodiments.

FIG. 4b shows a system model for dual TRP, dual UE panel beamforming according to various exemplary embodiments.

FIG. 5 shows a method for single TRP, dual-stream and/or dual TRP, dual-stream beam management with dual-polarization antenna arrays from a gNB perspective according to various exemplary embodiments.

FIG. 6 shows a method for single TRP, dual-stream and/or dual TRP, dual-stream beam management with dual-polarization antenna arrays from a UE perspective according to various exemplary embodiments.

FIG. 7 shows an exemplary network arrangement according to various exemplary embodiments.

FIG. 8 shows an exemplary base station according to various exemplary embodiments.

FIG. 9 shows an exemplary UE according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for optimizing a communication link between one or more transmission and reception points (TRPs) of a next generation node B (gNB) and a user equipment (UE) to optimize the capacity of the link between the gNB and the UE. In various embodiments, aspects of beamforming including digital precoding, analog beamforming, phase shifting and digital combining are considered separately and in combination.

In some embodiments, the effect of different polarizations of a dual-polarization antenna can be observed by transmitting multiple signals, e.g., channel state information (CSI) reference signals (CSI-RS), with different precoding. In dual-polarization antenna communications, one sub-array (one physical port) of the transmit (Tx) antenna is polarized differently from another sub-array of the Tx antenna so that the combined polarization of the transmitted beam can be controlled. In some embodiments, e.g., single port (digital port) transmissions, the multiple CSI-RS can be sent across the time domain, e.g., in a same symbol or across multiple symbols, with different precoding to observe the effect of different polarizations on the resulting channels. In other embodiments, e.g., dual-port (digital port) transmissions, the multiple CSI-RS can be sent simultaneously across the frequency domain.

In some embodiments, the capacity from the transmitted symbols to the input of the digital combiner is estimated by a capacity metric. The capacity metric can be computed by the UE for each of a plurality of different beam pairs. The UE can select and report one or more of the best beam pairs in a group-based channel state information (CSI) report.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) radio access network (RAN). However, reference to a 5G NR RAN is merely provided for illustrative purposes. The exemplary embodiments may be utilized with any network implementing beamforming techniques similar to those described herein. Therefore, the 5G NR network as described herein may represent any type of network implementing similar beamforming functionalities as the 5G NR network.

In addition, some exemplary embodiments are described with regard to a next generation node B (gNB) that is configured with multiple TRPs. Throughout this description, a TRP generally refers to a set of components configured to communicate with a UE. In some embodiments, multiple TRPs may be deployed locally at the gNB. For example, the gNB may include multiple antenna arrays/panels that are each configured to generate a different beam. In other embodiments, multiple TRPs may be deployed at various different physical locations and are connected to the gNB via a backhaul connection. For example, multiple small cells may be deployed at different physical locations and connected via backhaul links to the gNB. However, these examples are merely provided for illustrative purposes. TRPs may be configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to communicate with a UE.

In some example embodiments, it is described that measurement results for a channel are better for a first configuration (e.g., first polarization configuration) than a second configuration (e.g., second polarization configuration). This relative term should be understood to mean a comparison of any objective measurement that indicates a channel quality such as an Reference Signal Received Power (RSRP), a Reference Signal Received Quality (RSRQ), Signal to Interference Noise Ratio (SINR), Received Signal Strength Indication (RSSI), etc.

In some aspects, operations are described for optimizing the communication link in a single TRP, single stream configuration. In other aspects, operations are described for optimizing the communication link in a single TRP, dual stream configuration. In still other aspects, operations are described for optimizing the communication link in a dual TRP, dual stream configuration.

Multiple input multiple output (MIMO) refers to antenna techniques to increase data throughput by using multiple transmitter antennas and multiple receiver antennas. Multiple independent data streams (or layers) can be transmitted by a TRP simultaneously by respective Tx antenna sub-arrays (physical Tx ports) and received by a UE by respective Rx antenna sub-arrays (physical Rx ports). Polarization MIMO refers to MIMO techniques in which different layers are transmitted through different sets of dual-polarized antenna elements of an antenna array.

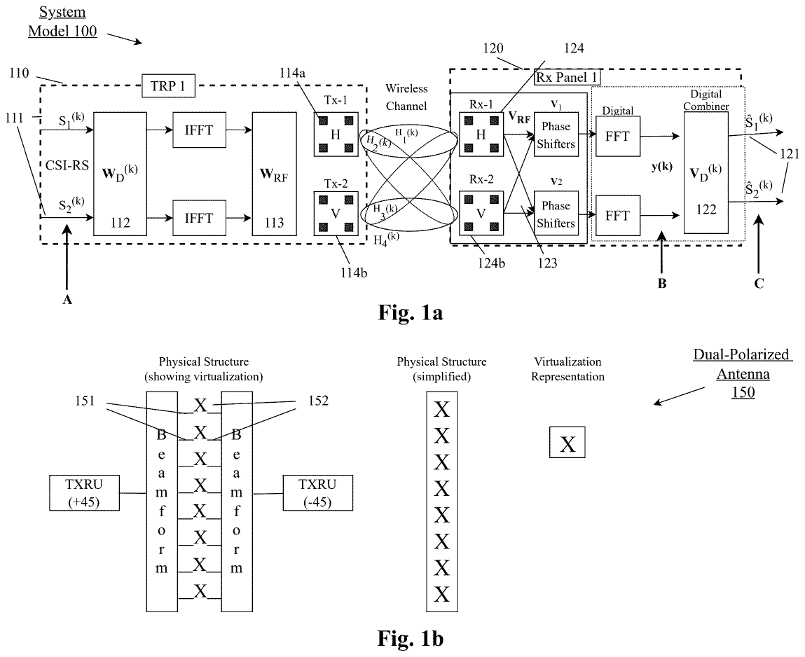

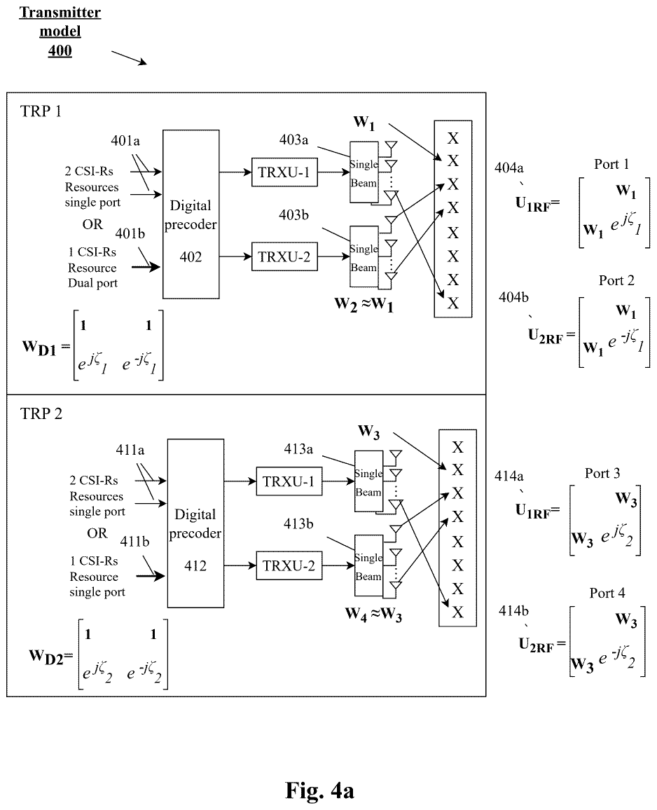

FIG. 1a shows a system model 100 for single TRP, single UE panel beamforming according to various exemplary embodiments. In this example, a TRP 110 comprises two Tx ports 114 (physical ports), e.g., a first Tx port 114a and a second Tx port 114b, and a UE 120 comprises a single Rx panel including two Rx ports 124, e.g., a first Rx port 124a and a second Rx port 124b. In other cases, to be described in greater detail below with regard to FIG. 4b, a system model comprising two TRPs each comprising two Tx ports and a UE comprising two Rx panels each comprising two Rx ports will be considered.

The TRP 101 can generate a data signal s(k) 111 at carrier k for transmission at point A of the system model 100. In this example, two signals s₁(k) and s₂(k) are generated simultaneously (e.g., dual stream). In other cases, a single signal s(k) is generated at a time (e.g., single stream). In some cases, the signal s(k) may be a reference signal, e.g., CSI-RS. To be described in greater detail below, the CSI-RS may be transmitted by the TRP 110 during a beam sweeping procedure, e.g., a P1 or P2 procedure.

Forming a Tx beam comprises two parts including a digital part controlling the polarization (digital antenna ports) and an analog part controlling the antenna array (physical antenna ports). The digital part is formed by a precoder 112 that controls the polarization. The signal(s) 111 are pre-coded by the digital precoder 112 with W_{D}(k) (digital part of Tx beamforming), to be described in greater detail below. The pre-coded signal(s) are processed with an inverse fast Fourier transform (IFFT) to create the time domain waveform and then beamformed by the baseband processor 113 with W_{RF} (analog part of Tx beamforming). Each beamformed signal can be transmitted by a respective sub-array 114 of the antenna (physical antenna port). In this example, a first Tx port (Tx-1) 114a is horizontally polarized and a second Tx port (Tx-2) 114b is vertically polarized.

H(k) represents a MIMO channel 115 between the Tx ports 114 of the TRP 110 and the Rx ports 124 of the UE 120. A wireless channel H(k) 115 is established between each Tx port and each Rx port, e.g., a first wireless channel H₁(k) is established between a first Tx port (Tx-1) and a first Rx port (Rx-1), a second wireless channel H₂(k) is established between the first Tx port (Tx-1) and a second Rx port (Rx-2), a third wireless channel H₃(k) is established between a second Tx port (Tx-2) and the first Rx port (Rx-1), and a fourth wireless channel H₄(k) is established between the second Tx port (Tx-2) and the second Rx port (Rx-2).

The wireless channels H(k) 115 are received at the baseband processor 123 of the UE 120 and Rx beamformed (phase shifted) by V_{RF}, which is defined by phase shifting terms v₁ and v₂, and a fast Fourier transform (FFT) is applied to decompose the beams into frequency components. The output of these processes at point B is input to the digital combiner 122, to be described in greater detail below. The signals are combined with V_{D}(k) (digital part of Rx beamforming) and the signals 121 (ŝ₁(k) and ŝ₂(k)) are identified at point C.

The W_{D}, W_{RF}, V_{D} and V_{RF} terms can be set to optimize the capacity from point A to point C. Jointly optimizing these terms is complicated. In the following, the problem is decoupled so that each part of the communication link described above is optimized at a different stage of processing.

First, the W_{D} term defining the digital precoding is considered. An electric field can be described as E=E_{θ}e^{φ}^{_{θ}}\hat{θ}+E_{φ}e^{φ}^{_{φ}}\hat{φ}. The coordinates of a polarization vector can be described as \hat{ψ}=\hat{ψ}₁\hat{θ}+\hat{ψ}₂\hat{φ}. For example, a polarization vector of +45 degrees can be described as

$${\hat{ψ}}_{+ 45} = \frac{1}{\sqrt{2}} [ \begin{matrix}1 \\ 1\end{matrix} ]$$

and a polarization vector of −45 degrees can be described as

$${\hat{ψ}}_{- 45} = \frac{1}{\sqrt{2}} [ \begin{matrix}1 \\ - 1\end{matrix} ] .$$

An arbitrary polarization can be described as a linear combination of two orthogonal polarizations as \hat{ψ}=α\hat{ψ}_{VP}+β\hat{ψ}_{HP}=γ\hat{ψ}₊₄₅+δ\hat{ψ}₋₄₅.

In general, two sub-arrays of a TRP (each Tx sub-array has an orthogonal polarization) has the same beam weight w (Tx analog beamforming) but its polarization is controlled through the coefficients γ, δ, which is achieved through digital precoding. For example, a vertical polarization

$$\hat{ψ} = [ \begin{matrix}1 \\ 0\end{matrix} ]$$

can be obtained from a +45 degree polarization weighted with

$$γ = \frac{1}{\sqrt{2}}$$

and a −45 degree polarization weighted with

$$δ = \frac{1}{\sqrt{2}} wherein \hat{ψ} = γ {\hat{ψ}}_{+ 45} + δ {\hat{ψ}}_{- 45} = [ \begin{matrix}1 \\ 0\end{matrix} ] .$$

A horizontal polarization

$$\hat{ψ} = [ \begin{matrix}0 \\ 1\end{matrix} ]$$

can be obtained from a +45 degree polarization weighted with

$$[ [ γ = \frac{1}{\sqrt{2}} ] ] ?$$

and a −45 degree polarization weighted with

$$[ [ δ = \frac{1}{\sqrt{2}} ] ] ? wherein \hat{ψ} = γ {\hat{ψ}}_{+ 45} + δ {\hat{ψ}}_{- 45} = [ \begin{matrix}0 \\ 1\end{matrix} ] .$$

It is noted that orthogonal polarizations of +/−45 degrees for a dual-polarized antenna array is referred to as slant polarization. Other types of polarization include circular polarization and elliptical polarization, wherein the polarization rotates as the signal propagates.

In some cases, for two antenna sub-arrays, each sub-array has an orthogonal polarization. Virtualization refers to the use of precoding for mapping a data stream to a group of physical antennas to form a virtual antenna.

FIG. 1b shows a dual-polarized antenna array 150 according to various exemplary embodiments. A first group of antenna elements 151 is polarized with a +45 degree polarization and a second group of antenna elements 152 is polarized with a −45 degree polarization. In this example, the first and second groups of antenna elements 151, 152 each comprise eight antenna elements. These respective groups can be represented as single virtualized antennas. These respective groups of antenna elements may also be referred to as respective physical ports of the TRP.

The antenna elements 151 of the first port are beamformed with weight vector w₁ and the antenna elements 152 of the second port are beamformed with weight vector w₂. The weight vectors w₁ and w₂ point in the same direction but are slightly different due to impairments. In the present embodiments, the weight vectors can be assumed to be the same, e.g., w₂=w₁.

According to one aspect of these exemplary embodiments, operations are described for optimizing the communication link being a gNB and a UE for single TRP, single stream communications. In these embodiments, the single TRP comprises a dual-polarization antenna including two physical Tx antenna ports and the UE comprises a single Rx antenna including two physical Rx ports. In these embodiments, a single digital data stream (Tx chain or digital port) is mapped to both physical Tx ports of the TRP.

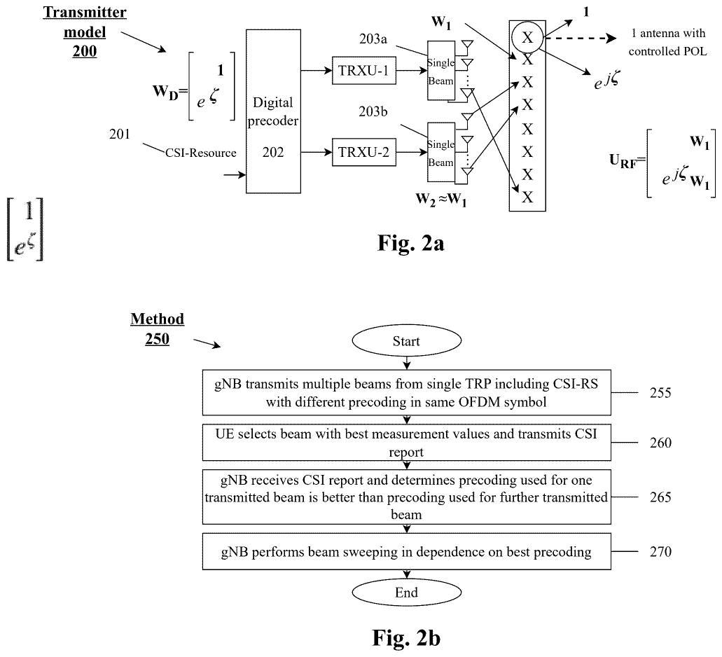

FIG. 2a shows a transmitter model 200 for single TRP, single stream beamforming with a dual-polarization antenna array according to various exemplary embodiments. For single TRP, single stream transmissions, a single (digital) port CSI-RS resource 201 can be transmitted by both physical (analog) ports 203a, 203b of the TRP. In this example, the single port CSI-RS resource 201 is precoded by the digital precoder 202 with

$${w}_{D} = [ \begin{matrix}1 \\ {e}^{ζ}\end{matrix} ] ,$$

wherein e^{ζ} refers to an arbitrary polarization.

As described above, the analog part of beamforming controls the physical antenna array and the digital part of beamforming, i.e., the precoder, controls the polarization. The weight vectors w for each physical port can be assumed to be the same, e.g., w₁. The effective transmitted beam 204 is described as

$${u}_{RF} = [ \begin{matrix}{w}_{1} \\ {e}^{j ζ} {w}_{1}\end{matrix} ] .$$

By combining the corresponding antenna elements, the polarization control can be seen.

In view of the above, it can be observed how different effective polarizations achieved by the dual polarization antenna array can affect the channels H(k) between the TRP and the UE. In single stream communications only a single beam is transmitted at a time, e.g., there is no simultaneous transmission of multiple beams in the time domain, contrary to the embodiments described below for single TRP, dual stream and dual TRP, dual stream. Thus, in order to observe the effect of different effective polarizations, two CSI-RS resources can be transmitted with different digital precoders in the same OFDM symbol. Since digital precoding cannot control the beamforming direction, the analog beamforming remains the same among the polarization subarrays.

The different digital precoding changes the polarizations of the antenna ports such that the two CSI-RS transmissions can result in different RSRP values. These observed differences in RSRP can be leveraged in beam management processes.

Beam management generally refers to a set of procedures configured to acquire and maintain a beam between a TRP and the UE. P1, P2 and P3 refer to processes for beam management during initial access and while in the CONNECTED state.

In the P1 process, the gNB (TRP) performs Tx beam sweeping of SSBs, typically from a set of different beams, and the UE performs Rx wide beam sweeping from a set of different beams. The UE measures the signal strength (e.g., RSRP) of each of the received SSB beams and selects the best beam to report to the gNB.

In the P2 process the gNB (TRP) performs beam refinement by performing Tx beam sweeping of CSI-RS, possibly from a smaller set of beams than the P1 process, and the UE performs Rx wide beam sweeping from a set of different beams. The P2 Tx beam sweeping can be narrower than that of P1. The UE measures the signal strength (e.g., RSRP) of the received CSI-RS beams and selects the best beam to report to the gNB. In the P3 process the gNB (TRP) repeatedly transmits the same beam and the UE refines its Rx beam.

Returning to the single TRP, single stream scenario described above, when multiple CSI-RS are transmitted with different polarizations, the UE could select the beam with the best polarization that maximizes RSRP. Since digital precoding would only affect the effective polarization (for example linear versus circular) the Tx beam scanning takes place in the time domain. Multiple CSI-RS resources can be sent across different OFDM symbols to change the Tx beams (P2 procedure). The UE performs its own independent RF beam scanning and the resulting Tx, Rx beam pair can be established.

FIG. 2b shows a method 250 for single TRP, single stream beam management with a dual-polarization antenna array according to various exemplary embodiments. In this example, the single TRP is controlled by a gNB and comprises two dual-polarized Tx ports and a UE comprises a single Rx panel comprising two Rx ports.

In 205, the gNB transmits multiple beams from the single TRP, e.g., two CSI-RS, in the same OFDM symbol, wherein the multiple beams each have different precoding resulting in different polarizations when transmitted by the Tx antenna array.

In 210, the UE receives the transmitted beams at its Rx panel, performs measurements on the beams, selects the best beam and transmits a CSI report. These processes may be part of a P1 process for beam management.

In 215, the gNB receives the CSI report and observes which precoding resulted in the best beam. For example, the polarization resulting from a first precoding may have resulted in a better channel than the polarization resulting from a second precoding.

In 220, the gNB performs Tx beamsweeping in dependence on the observed effect of different Tx precoding/polarization, e.g., as part of a P2 process for beam management.

It is noted that the exemplary embodiments are applicable to mostly analog Tx RF architectures, Hybrid Beamforming (HBF) architectures, or fully digital Tx RF architectures.

According to further aspects of these exemplary embodiments, operations are described for optimizing the MIMO communication link between a gNB and a UE for single TRP, dual-stream communications and dual-TRP, dual-stream communications. In these embodiments, similar to above, the TRP(s) (single or dual) (each) comprise a dual-polarization antenna including two physical Tx antenna ports and the UE comprises one or more Rx antenna panel(s) (each) including two physical Rx ports. In these embodiments, two data streams (Tx chain or digital port) are mapped to respective Tx ports of the TRP(s). In the following, metrics are described for selecting the best Tx beam pair. Subsequent CQI link adaptations could optimize the precoders, to be described in greater detail below.

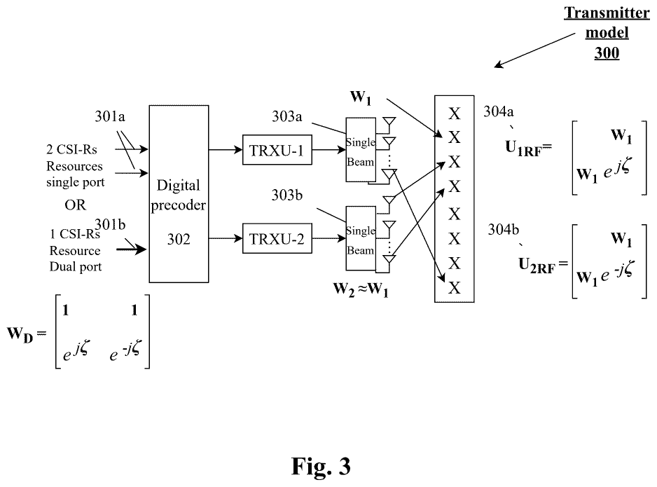

FIG. 3 shows a transmitter model 300 for single TRP, dual-stream beamforming according to various exemplary embodiments. For single TRP, dual-stream transmissions, two (digital) port CSI-RS resources 301a can be transmitted by respective physical (analog) ports 303 of the TRP, e.g., a first Tx port 303a and a second Tx port 303b, or one (digital) port CSI-resource 301b can be transmitted by both physical (analog) ports 303 of the TRP. For two streams and one TRP precoding is applied across the two different single port CSI-RS resources or the one CSI-RS resource with dual port. Conceptually, these two schemes should be the same. In this example, the two single port CSI-RS resources 301a or one dual-port CSI-RS resource 301b is precoded with

$${w}_{D} = [ \begin{matrix}1 & 1 \\ {e}^{j ζ} & {e}^{- j ζ}\end{matrix} ] .$$

As described above, the analog part of beamforming controls the antenna array and the digital part of beamforming, i.e., the precoder, controls the polarization. The weight vectors w for each physical port can be assumed to be the same, e.g., w₁, similar to above. The effective transmitted beam 304a for the first port is described as

$${u}_{1 RF} = [ \begin{matrix}{w}_{1} \\ {w}_{1} {e}^{j ζ}\end{matrix} ]$$

and the effective transmitted beam 304b for the second port will be sent as

$${u}_{2 RF} = [ \begin{matrix}{w}_{1} \\ {w}_{1} {e}^{- j ζ}\end{matrix} ] .$$

Returning to FIG. 1a (showing single TRP, dual stream), the system model from the transmitter (point A) to the digital combiner input (point B) is

$$y ( k ) = {V}_{RF}^{H} H ( k ) {W}_{RF} {W}_{D} ( k ) s ( k ) + {V}_{RF}^{H} n ( k ) \qquad k = 0 , … , K - 1.$$

The weighted noise

$$z = {V}_{RF}^{H} n$$

is correlated with correlation matrix K_{z}. By multiplying with the factor

$${K}_{z}^{- \frac{1}{2}} ,$$

the capacity from the transmitted symbols to the input of the digital combiner is

$$C = arg max {\sum }_{\vert V ( i , j ) \vert = 1 k = 1}^{{N}_{fft}} log ( \vert {I}_{2} + ρ {K}_{z}^{- \frac{1}{2}} {V}_{RF}^{H} G ( k ) {G}^{H} ( k ) {V}_{RF} {K}_{z}^{- \frac{1}{2}} \vert )$$

$$k = 0 , … , {N}_{fft} - 1 ,$$

where the covariance matrix is given by

$${K}_{z} = {V}_{RF}^{H} {V}_{RF} . Since det ( {I}_{N} + AB ) = det ( {I}_{N} + BA ) ,$$

a capacity metric

$$C = arg max {\sum }_{\vert V ( i , j ) \vert = 1 k = 1}^{{N}_{fft}} log ( \vert {I}_{2} + {ρ ( {V}_{RF}^{H} {V}_{RF} )}^{- 1} {V}_{RF}^{H} G ( k ) {G}^{H} ( k ) {V}_{RF} \vert )$$

$$k = 0 , … , {N}_{fft} - 1$$

can be obtained.

G(k) is the virtualized effective channel and is shown by

$$G ( k ) = [ \begin{matrix}{H}_{1} ( k ) & {H}_{2} ( k ) \\ {H}_{3} ( k ) & {H}_{4} ( k )\end{matrix} ] \cdot {W}_{Rf} \cdot {W}_{D} ( k ) = [ \begin{matrix}{g}_{1} ( k ) & {g}_{3} ( k ) \\ {g}_{2} ( k ) & {g}_{4} ( k )\end{matrix} ]$$

$$k = 0 , … , {N}_{fft} - 1 ; {G ( k )}_{8 \times 2} .$$

The virtualized effective channel G(k) is a function of the digital precoder at TRP1 and the analog beam at TRP1. It is assumed the TRP1 sweeps with N beams. The channel G(k) captures the channel from the 2-port TRP, analog beamforming, wireless channel to the input of the H, V antennas at the Rx panel of the UE. This channel can be estimated with 2-port CSI-RS over many symbols (e.g., 4 symbols) or with 2 CSI-RS resources. Measurements are performed to estimate the channel during the training phase. The phase shifters can use a measurement-based phase shifting matrix described as

$${V}_{RF} = {[ \begin{matrix}{v}_{1} & 0 \\ 0 & {v}_{2}\end{matrix} ]}_{8 \times 2} ⇒ {( {V}_{RF}^{H} {V}_{RF} )}^{- 1} ⇒ {N}_{R} I .$$

This simplification is arrived at by assuming large scale MIMO antennas. The UE can solve for the best v₁, v₂ values to compute the best Rx beam.

FIG. 4a shows a transmitter model 400 for dual TRP, dual-stream beamforming according to various exemplary embodiments. For dual TRP, dual-stream transmissions, two (digital) port CSI-RS resources 401a can be transmitted by respective physical (analog) ports 403 of the first TRP, e.g., a first Tx port 403a and a second Tx port 403b, or one (digital) port CSI-resource 401b can be transmitted by both physical (analog) ports 403 of the first TRP, and two (digital) port CSI-RS resources 411a can be transmitted by respective physical (analog) ports 413 of the first TRP, e.g., a first Tx port 413a and a second Tx port 413b, or one (digital) port CSI-resource 411b can be transmitted by both physical (analog) ports 413 of the second TRP. Similar to above, for two streams precoding is applied across the two different single port CSI-RS resources or the one CSI-RS resource with dual port, for each TRP. In this example, the two single port CSI-RS resources 401a or one dual-port CSI-RS resource 401b of the first TRP is precoded with

$${W}_{{D}_{1}} = [ \begin{matrix}1 & 1 \\ {e}^{j {ζ}_{1}} & {e}^{- j {ζ}_{1}}\end{matrix} ]$$

and the two single port CSI-RS resources 411a or one dual-port CSI-RS resource 411b of the second TRP is precoded with

$${W}_{{D}_{2}} = [ \begin{matrix}1 & 1 \\ {e}^{j {ζ}_{2}} & {e}^{- j {ζ}_{2}}\end{matrix} ] .$$

The weight vectors w for each physical port of each TRP can be assumed to be the same similar to above. For dual TRP we have another TRP which points to a different angle of departure (AoD) (through weight vector w₃). The effective (over precoding and beamforming) transmitted beam 404a for the first port of the first TRP is described as

$${u}_{1 RF} = [ \begin{matrix}{w}_{1} \\ {w}_{1} {e}^{j {ζ}_{1}}\end{matrix} ]$$

and the effective transmitted beam 404b for the second port of the first TRP will be sent as

$${u}_{2 RF} = [ \begin{matrix}{w}_{1} \\ {w}_{1} {e}^{- j {ζ}_{1}}\end{matrix} ] .$$

The effective transmitted beam 414a for the first port of the second TRP is described as

$${u}_{3 RF} = [ \begin{matrix}{w}_{3} \\ {w}_{3} {e}^{j {ζ}_{2}}\end{matrix} ]$$

and the effective transmitted beam 414b for the second port of the second TRP will be sent as

$${u}_{4 RF} = [ \begin{matrix}{w}_{3} \\ {w}_{3} {e}^{- j {ζ}_{2}}\end{matrix} ] .$$

FIG. 4b shows a system model 450 for dual TRP, dual UE panel beamforming according to various exemplary embodiments. In this example, a first TRP 460 comprises two Tx ports 464 (physical ports), e.g., a first Tx port 464a and a second Tx port 464b, and a second TRP 480 comprises two Tx ports 484 (physical ports), e.g., a first Tx port 484a and a second Tx port 484b. A UE comprises two Rx panels each including two Rx ports, e.g., a first Rx panel 470 including a first Rx port 474a and a second Rx port 474b and a second Rx panel 490 including a first Rx port 494a and a second Rx port 494b.

In this example, two signals s₁(k) and s₂(k), e.g., CSI-RS, are generated simultaneously (e.g., dual stream) by each TRP, e.g., signals 461 are generated by the first TRP 460 and signals 471 are generated by the second TRP 470. The CSI-RS may be transmitted by the TRPs 460, 470 during a beam sweeping procedure, e.g., a P1 or P2 procedure.

The signal(s) 461 generated by the first TRP 460 are pre-coded by the precoder 462 with W_{D}_{₁}(k) and the signals 481 generated by the second TRP 480 are pre-coded by the precoder 482 with W_{D}_{₂}(k). The pre-coded signals are processed with an inverse fast Fourier transform (IFFT) to create the time domain waveform and then beamformed by the baseband processors 463 of the first TRP 460 with W_{1RF} and by the baseband processors 483 of the second TRP 480 with W_{2RF}. Each beamformed signal can be transmitted by a respective sub-array of the antenna (physical antenna port). In this example, for the first TRP 460, a first Tx port (Tx-1) 464a is horizontally polarized and a second Tx port (Tx-2) 464b is vertically polarized, and, for the second TRP 480, a first Tx port (Tx-1) 484a is horizontally polarized and a second Tx port (Tx-2) 484b is vertically polarized.

H(k) and/or V(k) represents MIMO channels 465 between the Tx ports 464 of the first TRP 460 and the Rx ports 474 of the first Rx panel 470 of the UE and MIMO channels 485 between the Tx ports 484 of the second TRP 480 and the Rx ports 494 of the second Rx panel 490 of the UE. A wireless channel H(k)/V(k) 465 is established between each Tx port and each Rx port. For the first TRP 460 and the first UE panel 470 a first wireless channel H₁H₁(k) is established between Tx-1 464a and Rx-1 474a, a second wireless channel V₁H₁(k) is established between Tx-1 464a and Rx-2 474b, a third wireless channel H₁V₁(k) is established between Tx-2 464b and Rx-1 474b, and a fourth wireless channel V₁V₁(k) is established between Tx-2 464b and Rx-2 474b. For the second TRP 480 and the second UE panel 490 a first wireless channel H₂H₂(k) is established between Tx-1 484a and Rx-1 494a, a second wireless channel V₂H₂(k) is established between Tx-1 484a and Rx-2 494b, a third wireless channel H₂V₂(k) is established between Tx-2 484b and Rx-1 494b, and a fourth wireless channel V₂V₂(k) is established between Tx-2 484b and Rx-2 494b.

It is noted that, in dual TRP communications, there is some cross-TRP channel leakage establishing interference channels between the first TRP 460 and the second UE Rx panel 490 and between the second TRP 480 and the first UE Rx panel 470. For example, a channel H₁H₂(k) is established between Tx-1 484a of the second TRP 480 and Rx-1 474a of the first UE Rx panel 470 and V₁H₂(k) is established between Tx-1 484a of the second TRP 480 and Rx-2 474b of the first UE Rx panel 470. This leakage is accounted for in the algorithms described below for optimizing the beam pair in dual TRP communications.

The wireless channels 465 are received at the baseband processor 473 of the first Rx panel 470 and beamformed by V_{RF1}, phase shifted by v₁ and v₂, and a fast Fourier transform (FFT) is applied to decompose the beams into frequency components. The output of these processes at point B is input to the digital combiner 472. The signals are combined with V_{D1}(k) and the signals 471 (ŝ₁(k) and ŝ₂(k)) are identified at point C. The wireless channels 485 are received at the baseband processor 493 of the first Rx panel 490 and beamformed by V_{RF2}, phase shifted by v₃ and v₄, and a fast Fourier transform (FFT) is applied to decompose the beams into frequency components. The output of these processes at point B is input to the digital combiner 492. The signals are combined with V_{D2}(k) and the signals 491 (ŝ₃(k) and ŝ₄(k)) are identified at point C.

Similar to the embodiments described above for single TRP, dual stream, in dual TRP, dual stream the data signals generated at the TRPs can comprise one dual-port CSI-RS resource or two single port CSI-RS resources (FD-CDM2) per TRP. In either scenario, the same phase shifting v is used per H and V.

The precoder can be described as

$${W}_{D} = {[ \begin{matrix}1 & 1 \\ {e}^{j β} & {e}^{- j β}\end{matrix} ]}_{8 \times 2}$$

and the analog beamforming can be described as

$${W}_{RF} = {[ \begin{matrix}w & 0 \\ 0 & w\end{matrix} ]}_{8 \times 2}$$

per TRP. The first RF chain (digital port) will be mapped to antennas as

$${W}_{RF} = {[ \begin{matrix}w \\ {we}^{j β}\end{matrix} ]}_{8 \times 1}$$

and the second RF chain (digital port) will be mapped to antennas as

$${W}_{RF} = {[ \begin{matrix}w \\ {we}^{- j β}\end{matrix} ]}_{8 \times 1} . {The [ \begin{matrix}w \\ {we}^{j β}\end{matrix} ]}_{8 \times 1}$$

effectively controls the effective polarization of the dual-polarization antennas of the first port and the

$${[ \begin{matrix}w \\ {we}^{j β}\end{matrix} ]}_{8 \times 1}$$

controls the effective polarization of the dual-polarization antennas of the second port, per TRP.

The system model from the transmitter to the digital combiner input is

$$y ( k ) = {V}_{RF}^{H} H ( k ) {W}_{RF} {W}_{D} ( k ) s ( k ) + {V}_{RF}^{H} n ( k ) k = 0 , … , K - 1 ,$$

where now the digital precoder is

$${W}_{D} ( k ) = {[ \begin{matrix}{W}_{{D}_{1}} ( k ) & 0 \\ 0 & {W}_{{D}_{2}} ( k )\end{matrix} ]}_{4 \times 4}$$

and the analog beamformer is

$${W}_{RF} = {[ \begin{matrix}{W}_{{RF}_{1}} & 0 \\ 0 & {W}_{{RF}_{2}}\end{matrix} ]}_{16 \times 4}$$

The Rx analog combiner across the two Rx panels is described as

$${V}_{RF} = {[ \begin{matrix}{v}_{1} & 0 & 0 & 0 \\ 0 & {v}_{2} & 0 & 0 \\ 0 & 0 & {v}_{3} & 0 \\ 0 & 0 & 0 & {v}_{4}\end{matrix} ]}_{16 \times 4}$$

The capacity metric for optimizing the Tx beam pair becomes

$$c = arg max {\sum }_{\vert V ( i , j ) \vert = 1 k = 1}^{K} log ( \vert {I}_{4} + ρ {V}_{RF}^{H} G ( k ) {G}^{H} ( k ) {V}_{RF} \vert ) k = 0 , … , K - 1.$$

Jensen's inequality

$$J = {\sum }_{k = 1}^{K} log ( \vert {I}_{4} + ρ {V}^{H} G ( k ) {G}^{H} ( k ) V \vert ) \leq K log ( \vert {I}_{4} + ρ {V}^{H} FV \vert )$$

is used, where

$$F = ( \frac{1}{K} ) {\sum }_{k = 1}^{K} G ( k ) {G}^{H} ( k ) .$$

The phase-shifting matrix can be described as

$${V}_{RF}^{*} = {\sum }_{V ( i , j ) ∈ Φ k = 1}^{K} log ( \vert {I}_{4} + ρ {V}^{H} G ( k ) {G}^{H} ( k ) V \vert ) k = 0 , … , K - 1. K - 1$$

The virtualized effective channel G(k) can be estimated at the UE based on beam measurement results for each beam pair. Each G(k) carries a beam pair j. The size of G(k) should be 16×4×K. The covariance matrix

$$F = {\sum }_{k = 1}^{K} G ( k ) {G}^{H} ( k )$$

can be estimated for each Tx beam pair j. Then, the best V can be computed for each beam pair j, where Jⱼ=log(|I₄+ρV^{H}FV|). The four best beam pairs can be selected among j=1 . . . . M. M can equal, e.g., 64.

In further embodiments, algorithms can be derived to solve for V given F. Due to the constraint of unit magnitude on the elements this is a nonlinear nonconvex problem and iterations are needed to solve for the optimum V.

In view of the above, in a first phase, for each Tx beam, measurements can be performed to estimate the channels from all TRP ports to the Rx antenna elements for all antenna panels (e.g., G(k) for each Tx beam pair). In a second phase, these channels from the first phase can be post-processed to evaluate the capacity metric. The first and second phases can be repeated for a different Tx beam pairs (different G(k) resulting in different capacity metrics). The gNB can transmit up to 64 different beams, and the UE can select the best four Tx/Rx beam pairs in a group-based CSI reporting configuration.

After the analog beam pairs have been established (Wrf, Vrf), demodulation is performed with the DMRS over the preferred beams. Vd can be an MMSE-IRC receiver. The network can subsequently trigger a CQI link adaptation such that the Wd is further optimized.

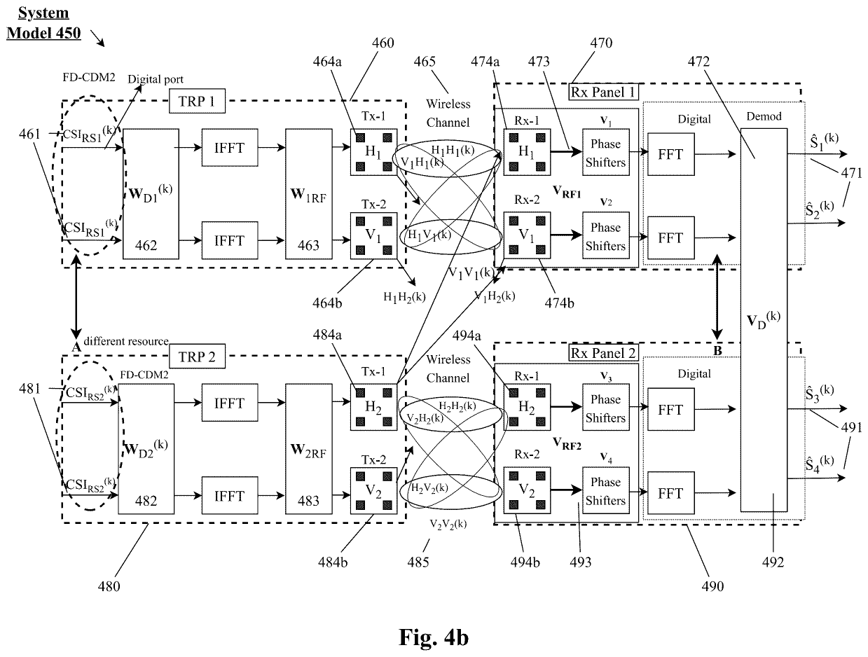

FIG. 5 shows a method 500 for single TRP, dual-stream and/or dual TRP, dual-stream beam management with dual-polarization antenna arrays from a gNB perspective according to various exemplary embodiments. In this example, each of the one or two TRPs is controlled by a gNB and each comprise two dual-polarized Tx ports and a UE comprises one or two Rx panels each comprising two Rx ports.

In 505, the gNB transmits multiple beams from the one or more TRPs, e.g., two one-port CSI-RS or one two-port CSI-RS per TRP, in the same OFDM symbol, wherein the multiple beams each have different precoding resulting in different polarizations when transmitted by the Tx antenna array.

In 510, the gNB receives the CSI report and observes which precoding and analog beam resulted in the best beam pair. For example, the polarization resulting from a first precoding may have resulted in a better channel than the polarization resulting from a second precoding.

In 515, the gNB transmits demodulation reference signals (DMRS) for the UE to perform demodulation (digital Rx beamforming).

In 520, the gNB can trigger a channel quality indicator (CQI) link adaptation to further optimize the digital precoder.

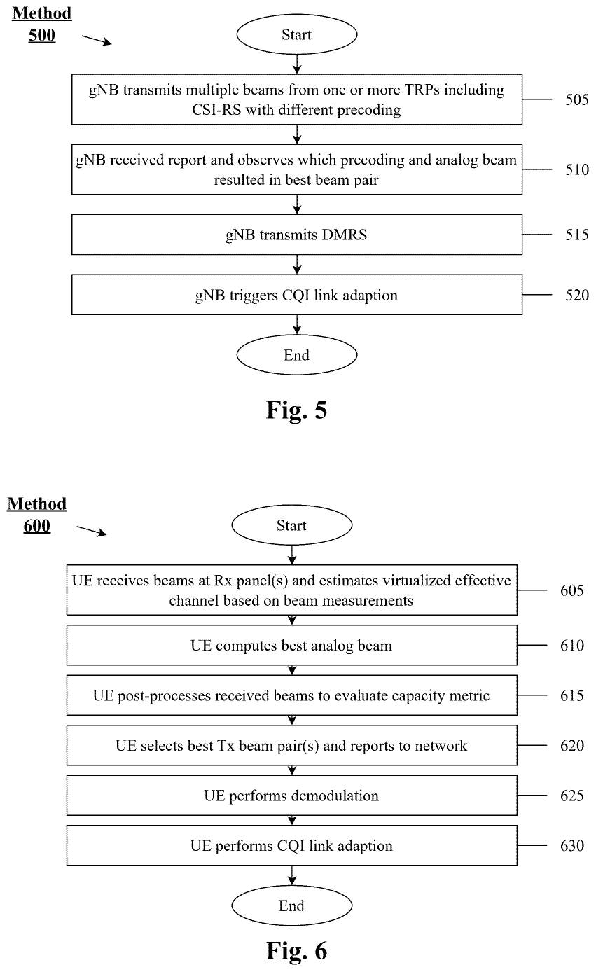

FIG. 6 shows a method 600 for single TRP, dual-stream and/or dual TRP, dual-stream beam management with dual-polarization antenna arrays from a UE perspective according to various exemplary embodiments. In this example, each of the one or two TRPs is controlled by a gNB and each comprise two dual-polarized Tx ports and a UE comprises one or two Rx panels each comprising two Rx ports.

In 605, the UE receives the transmitted beams at its Rx panel(s) and performs measurements on the beams to estimate the channels from all TRP ports to the Rx antenna elements for all antenna panels. The UE estimates the virtualized effective channel G(k) for each received beam.

In 610, the UE computes a best Rx beam by calculating, from the estimated virtualized effective channel, the best values for its analog beamforming phase-shifting matrix. The UE can compute these values for each received beam.

In 615, the UE post-processes the received channels for each beam to evaluate a capacity metric for each beam pair. The capacity metric can represent the capacity, e.g., throughput, from the digital precoder of the TRP(s), through the analog Tx beamforming, to the analog Rx beamforming. The capacity metric is dependent on the precoding, Tx beamforming, and Rx beamforming.

In 620, the UE selects the best Tx beam pair(s) and reports the best Tx beam pair(s). For example, the UE can select the four best Tx beam pairs and report these beam pairs in a group-based CSI report.

In 625, the UE performs demodulation.

In 630, the UE performs channel quality indicator (CQI) link adaptation processes to further optimize the digital precoder.

This proposal estimates the channel from the Tx ports to the Rx antenna elements and computes the best Rx beams from each Tx beam configuration. The proposed capacity-based beamforming can be also used in the codebook based Rx beamforming.

In the codebook case, the Rx tries a combination of beams for the two antenna panels and estimated the Baseband equivalent channels as a function of the Rx beams. The capacity metric is evaluated for the beam selection.

In a first phase, TRPs select a Tx beam pair to probe the channel over CSI-RS or SSB (txId). In a second phase, the UE selects a combination of Rx beams (rxId). The UE computes the baseband equivalent channel and evaluates the capacity metric J(txId, rxID).

The first and second phases can be repeated for a different Tx beam pairs and Rx beam pairs. The gNB can transmit up to 64 different beams, and the UE can select the best four Tx/Rx beam pairs in a group-based CSI reporting configuration. After the analog beam pairs have been established (Wrf, Vrf), demodulation is performed with the DMRS over the preferred beams. Vd can be an MMSE-IRC receiver. The network can subsequently trigger a CQI link adaptation such that the Wd is further optimized.

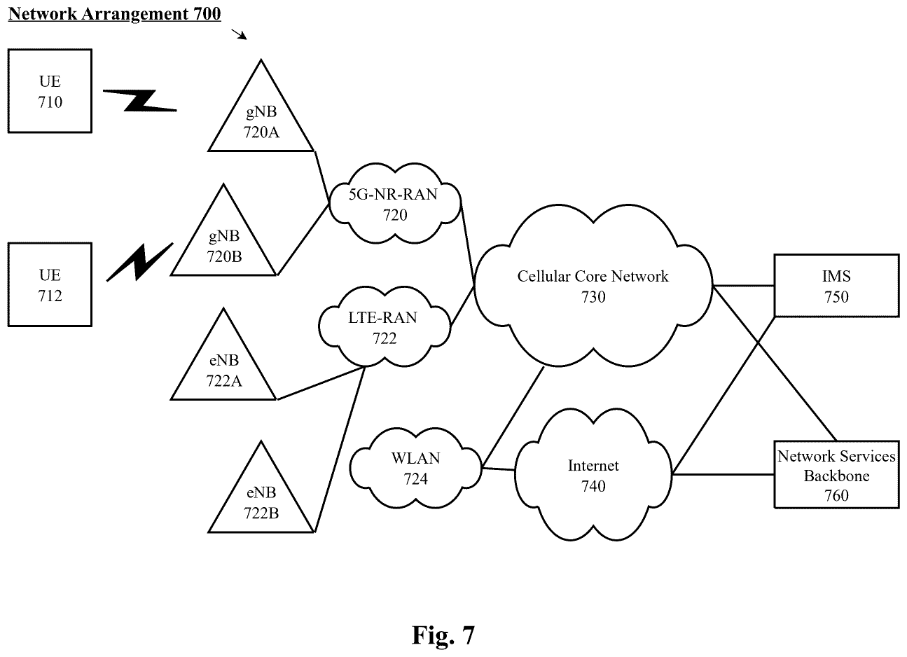

FIG. 7 shows an exemplary network arrangement 700 according to various exemplary embodiments. The exemplary network arrangement 700 includes UEs 710, 712. The UEs 710, 712 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. An actual network arrangement may include any number of UEs being used by any number of users. Thus, the example of two UEs 710, 712 is merely provided for illustrative purposes.

The UEs 710, 712 may communicate directly with one or more networks. In the example of the network configuration 700, the networks with which the UEs 710, 712 may wirelessly communicate are a 5G NR radio access network (5G NR-RAN) 720, an LTE radio access network (LTE-RAN) 722 and a wireless local access network (WLAN) 724. However, the UEs 710, 712 may also communicate with other types of networks and the UEs 710, 712 may also communicate with networks over a wired connection. Therefore, the UEs 710, 712 may include a 5G NR chipset to communicate UE 710 with the 5G NR-RAN 720, an LTE chipset to communicate with the LTE-RAN 722 and an ISM chipset to communicate with the WLAN 724.

The 5G NR-RAN 720 and the LTE-RAN 722 may be portions of cellular networks that may be deployed by a network carrier (e.g., Verizon, AT&T, T-Mobile, etc.). These networks 720, 722 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 724 may include any type of wireless local area network (WiFi, Hot Spot, IEEE 802.11x networks, etc.).

The UEs 710, 712 may connect to the 5G NR-RAN via the gNB 720A or the gNB 720B. Reference to two gNBs 720A, 720B is merely for illustrative purposes. The exemplary embodiments may apply to any appropriate number of gNBs. The UEs 710, 712 may also connect to the LTE-RAN 722 via the eNBs 722A, 722B. Any association procedure may be performed for the UEs 710, 712 to connect to the 5G NR-RAN 720 and the LTE-RAN 722. For example, as discussed above, the 5G NR-RAN 720 and the LTE-RAN 722 may be associated with a particular cellular provider where the UEs 710, 712 and/or the user thereof has a contract and credential information (e.g., stored on a SIM card). Upon detecting the presence of the 5G NR-RAN 720, the UEs 710, 712 may transmit the corresponding credential information to associate with the 5G NR-RAN 720. More specifically, the UEs 710, 712 may associate with a specific base station (e.g., the gNB 720A of the 5G NR-RAN 720, the eNB 722A of the LTE-RAN 722).

In addition to the networks 720, 722 and 724 the network arrangement 700 also includes a cellular core network 730, the Internet 740, an IP Multimedia Subsystem (IMS) 750, and a network services backbone 760. The cellular core network 730 may be considered to be the interconnected set of components that manages the operation and traffic of the cellular network. The cellular core network 730 also manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UEs 710, 712 in communication with the various networks.

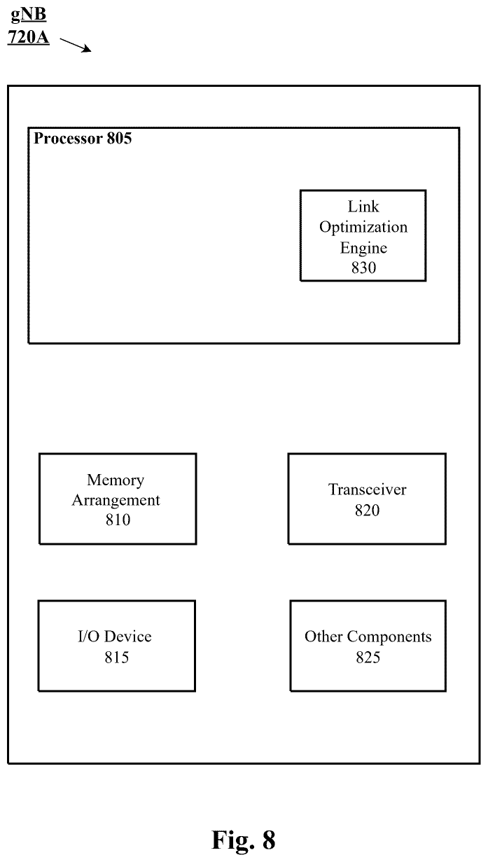

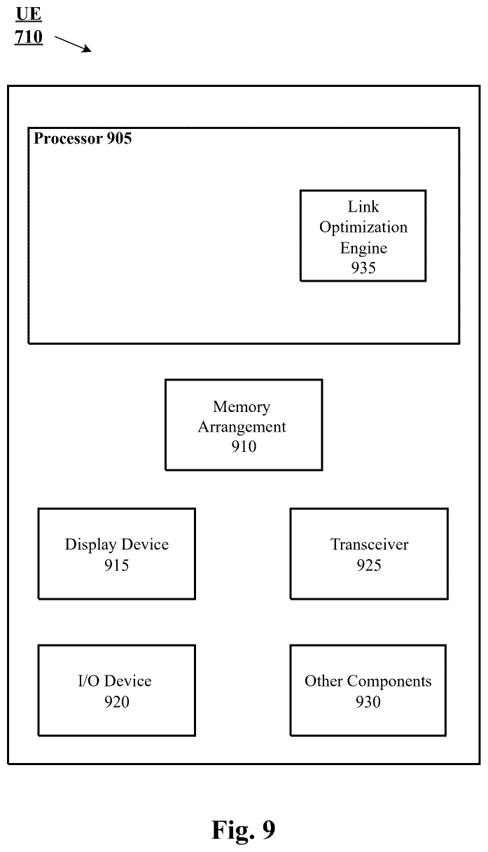

FIG. 8 shows an exemplary base station 720A according to various exemplary embodiments. The base station 720A will be described with regard to the network arrangement 700 of FIG. 7. The base station 720A may represent any access node through which the UE 710 may establish a connection and manage network operations. The base station 720A may also represent the gNB 720B described above with respect to FIG. 7.

The base station 720A may include a processor 805, a memory arrangement 810, an input/output (I/O) device 815, a transceiver 820, and other components 825. The other components 825 may include, for example, a battery, a data acquisition device, ports to electrically connect the base station 720A to other electronic devices, etc.

The processor 805 may be configured to execute a plurality of engines of the base station 720A. For example, the engines may include a link optimization engine 830 for performing operations related to performing beam management processes and optimizing the communication link with the UE by observing the effects of different digital precoding and analog beamforming, as described above.

The above noted engine 830 being an application (e.g., a program) executed by the processor 805 is only exemplary. The functionality associated with the engine 830 may also be represented as a separate incorporated component of the base station 720A or may be a modular component coupled to the base station 720A, e.g., an integrated circuit with or without firmware. For example, the integrated circuit may include input circuitry to receive signals and processing circuitry to process the signals and other information. In addition, in some base stations, the functionality described for the processor 805 is split among a plurality of processors (e.g., a baseband processor, an applications processor, etc.). The exemplary embodiments may be implemented in any of these or other configurations of a base station.

The memory 810 may be a hardware component configured to store data related to operations performed by the base station 720A. The I/O device 815 may be a hardware component or ports that enable a user to interact with the base station 720A.

The transceiver 820 may be a hardware component configured to exchange data with the UE 710 and any other UE in the system 700. The transceiver 820 may operate on a variety of different frequencies or channels (e.g., set of consecutive frequencies). Therefore, the transceiver 820 may include one or more components (e.g., radios) to enable the data exchange with the various networks and UEs. The transceiver 820 includes circuitry configured to transmit and/or receive signals (e.g., control signals, data signals). Such signals may be encoded with information implementing any one of the methods described herein. The processor 805 may be operably coupled to the transceiver 820 and configured to receive from and/or transmit signals to the transceiver 820. The processor 805 may be configured to encode and/or decode signals (e.g., signaling from a UE) for implementing any one of the methods described herein.

FIG. 8 shows an exemplary UE 710 according to various exemplary embodiments. The UE 710 will be described with regard to the network arrangement 700 of FIG. 4. The UE 710 may also represent UE 712. The UE 710 may include a processor 905, a memory arrangement 910, a display device 915, an input/output (I/O) device 920, a transceiver 925 and other components 930. The other components 930 may include, for example, an audio input device, an audio output device, a power supply, a data acquisition device, ports to electrically connect the UE 710 to other electronic devices, etc.

The processor 905 may be configured to execute a plurality of engines of the UE 710. For example, the engines may include a link optimization engine 935 for performing operations related to performing beam management processes with the network and optimizing the communication link with the network by computing a best receive beam and a capacity metric for received beams to select a best beam pair, as described above.

The above referenced engine 935 being an application (e.g., a program) executed by the processor 905 is provided merely for illustrative purposes. The functionality associated with the engine 935 may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 905 is split among two or more processors such as a baseband processor and an applications processor. The exemplary embodiments may be implemented in any of these or other configurations of a UE.

The memory arrangement 910 may be a hardware component configured to store data related to operations performed by the UE 710. The display device 915 may be a hardware component configured to show data to a user while the I/O device 920 may be a hardware component that enables the user to enter inputs. The display device 915 and the I/O device 920 may be separate components or integrated together such as a touchscreen.

The transceiver 925 may be a hardware component configured to establish a connection with the 5G NR-RAN 720 and/or any other appropriate type of network. Accordingly, the transceiver 925 may operate on a variety of different frequencies or channels (e.g., set of consecutive frequencies). The transceiver 925 includes circuitry configured to transmit and/or receive signals (e.g., control signals, data signals). Such signals may be encoded with information implementing any one of the methods described herein. The processor 905 may be operably coupled to the transceiver 925 and configured to receive from and/or transmit signals to the transceiver 925. The processor 905 may be configured to encode and/or decode signals (e.g., signaling from a base station of a network) for implementing any one of the methods described herein.

### EXAMPLES

In a first example, a method performed by a base station configured with at least one transmission and reception point (TRP) comprising a dual-polarization antenna array, the method comprising transmitting at least a first reference signal (RS) and a second RS in a same orthogonal frequency division multiplexing (OFDM) symbol, the first RS being generated with a first precoding and the second RS being generated with a second precoding different from the first precoding such that a first polarization of the first RS is different from a second polarization of the second RS, receiving a measurement report including measurement values for at least the first RS, determining that the first polarization resulted in first measurement values better than second measurement values resulting from the second polarization and beamsweeping further RS across different OFDM symbols in dependence on the determination that the first polarization resulted in the first measurement values better than the second measurement values resulting from the second polarization.

In a second example, the method of the first example, wherein the RS are channel state information RS (CSI-RS).

In a third example, the method of the first example, wherein the beamsweeping is part of a P2 procedure for beam management.

In a fourth example, the method of the first example, wherein the first polarization or the second polarization is a linear polarization, a circular polarization, or an elliptical polarization.

In a fifth example, the method of the first example, wherein the TRP comprises a dual-polarization antenna including two physical transmit ports.

In a sixth example, a processor configured to perform any of the methods of the first through fifth examples.

In a seventh example, a base station comprising a transceiver configured to communicate with a user equipment (UE) and a processor communicatively coupled to the transceiver and configured to perform any of the methods of the first through fifth examples.

In an eighth example, a processor of a base station configured with at least one transmission and reception point (TRP) comprising a dual-polarization antenna array, the method comprising transmitting at least a first reference signal (RS) and a second RS simultaneously in a dual-stream configuration, the first RS being generated with a first precoding and the second RS being generated with a second precoding different from the first precoding such that a first polarization of the first RS is different from a second polarization of the second RS, receiving a measurement report including measurement values for at least the first RS, determining that the first polarization resulted in first measurement values better than second measurement values resulting from the second polarization and triggering a channel quality indicator (CQI) link adaptation in dependence on the determination that the first polarization resulted in the first measurement values better than the second measurement values resulting from the second polarization.

In a ninth example, the method of the eighth example, further comprising receiving a report including one or more selected beam pairs.

In a tenth example, the method of the ninth example, wherein the report includes four best beams pairs.

In an eleventh example, the method of the ninth example, further comprising transmitting demodulation reference signals (DMRS) over one of the selected beam pairs.

In a twelfth example, the method of the eighth example, wherein the at least one TRP includes two physical transmit (Tx) ports.

In a thirteenth example, the method of the eighth example, wherein the base station comprises two TRPs each including two physical transmit (Tx) ports.

In a fourteenth example, a processor configured to perform any of the methods of the eighth through thirteenth examples.

In a fifteenth example, a base station comprising a transceiver configured to communicate with a user equipment (UE) and a processor communicatively coupled to the transceiver and configured to perform any of the methods of the eighth through thirteenth examples.

In a sixteenth example, a method performed by a user equipment (UE) comprising a dual-polarization antenna array configured to communicate with at least one transmission and reception point (TRP) of a base station, the method comprising receiving a plurality of reference signals (RS) from the at least one TRP, estimating a virtualized effective channel for each of the plurality of RS dependent on a digital precoding and transmit analog beamforming weights used by the at least one TRP to transmit the plurality of RS, determining a best analog receive beam based on the virtualized effective channel estimated for each of the plurality of RS, evaluating a capacity metric for each virtualized effective channel and selecting one or more best beam pairs based on the capacity metric.

In a seventeenth example, the method of the sixteenth example, further comprising reporting the one or more best beam pairs as a group.

In an eighteenth example, the method of the seventeenth example, wherein the UE selects four best beam pairs for reporting.

In a nineteenth example, the method of the sixteenth example, further comprising performing a channel quality indicator (CQI) link adaptation triggered by the base station.

In a twentieth example, the method of the sixteenth example, further comprising performing receive (Rx) beamsweeping to select a combination of Rx beams.

In a twenty first example, the method of the sixteenth example, further comprising using a combination of Rx beams and estimating a baseband equivalent channel as a function of the Rx beams.

In a twenty second example, the method of the sixteenth example, wherein the UE comprises a single receive (Rx) antenna panel comprising two physical Rx ports.

In a twenty third example, the method of the sixteenth example, wherein the UE comprises two receive (Rx) antenna panels each comprising two physical Rx ports.

In a twenty fourth example, the method of the sixteenth example, further comprising using a measurement based phase shifting matrix to determine a best analog receive (Rx) beam.

In a twenty fifth example, the method of the sixteenth example, further comprising solving for a best receive (Rx) beam for each transmit (Tx) beam pair based on the virtualized effective channel.

In a twenty sixth example, the method of the sixteenth example, further comprising performing demodulation over one of the selected beam pairs.

In a twenty seventh example, a processor configured to perform any of the methods of the sixteenth through twenty sixth examples.

In a twenty eighth example, a user equipment (UE) comprising a transceiver configured to communicate with a base station and a processor communicatively coupled to the transceiver and configured to perform any of the methods of the sixteenth through twenty sixth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. An apparatus of a base station configured with at least one transmission and reception point (TRP) comprising a dual-polarization antenna array, the apparatus comprising processing circuitry configured to:
generate at least a first reference signal (RS) and a second RS in a same orthogonal frequency division multiplexing (OFDM) symbol, the first RS being generated with a first precoding and the second RS being generated with a second precoding different from the first precoding such that a first polarization of the first RS is different from a second polarization of the second RS;
process a measurement report including measurement values for at least the first RS;
determine that the first polarization resulted in first measurement values better than second measurement values resulting from the second polarization; and
beamsweep further RS across different OFDM symbols in dependence on the determination that the first polarization resulted in the first measurement values better than the second measurement values resulting from the second polarization.

2. The apparatus of claim 1, wherein the RS are channel state information RS (CSI-RS).

3. The apparatus of claim 1, wherein the beamsweeping is part of a P2 procedure for beam management.

4. The apparatus of claim 1, wherein the first polarization or the second polarization is a linear polarization, a circular polarization, or an elliptical polarization.

5. The apparatus of claim 1, wherein the TRP comprises a dual-polarization antenna including two physical transmit ports.

6. An apparatus of a base station configured with at least one transmission and reception point (TRP) comprising a dual-polarization antenna array, the apparatus comprising processing circuitry configured to:
generate at least a first reference signal (RS) and a second RS simultaneously in a dual-stream configuration, the first RS being generated with a first precoding and the second RS being generated with a second precoding different from the first precoding such that a first polarization of the first RS is different from a second polarization of the second RS;
process a measurement report including measurement values for at least the first RS;
determine that the first polarization resulted in first measurement values better than second measurement values resulting from the second polarization; and
trigger a channel quality indicator (CQI) link adaptation in dependence on the determination that the first polarization resulted in the first measurement values better than the second measurement values resulting from the second polarization.

7. The apparatus of claim 6, wherein the processing circuitry is further configured to:
process a report including one or more selected beam pairs.

8. The apparatus of claim 7, wherein the report includes four best beams pairs.

9. The apparatus of claim 7, wherein the processing circuitry is further configured to:
generate demodulation reference signals (DMRS) over one of the selected beam pairs.

10. The apparatus of claim 6, wherein the at least one TRP includes two physical transmit (Tx) ports.

11. The apparatus of claim 6, wherein the base station comprises two TRPs each including two physical transmit (Tx) ports.

12. An apparatus of a user equipment (UE) comprising a dual-polarization antenna array configured to communicate with at least one transmission and reception point (TRP) of a base station, the apparatus comprising processing circuitry configured to:
process a plurality of reference signals (RS) from the at least one TRP;
estimate a virtualized effective channel for each of the plurality of RS dependent on a digital precoding and transmit analog beamforming weights used by the at least one TRP to transmit the plurality of RS;
determine a best analog receive beam based on the virtualized effective channel estimated for each of the plurality of RS;
evaluate a capacity metric for each virtualized effective channel; and
select one or more best beam pairs based on the capacity metric.

13. The apparatus of claim 12, wherein the processing circuitry is further configured to:
report the one or more best beam pairs as a group.

14. The apparatus of claim 12, wherein the processing circuitry is further configured to:
perform a channel quality indicator (CQI) link adaptation triggered by the base station.

15. The apparatus of claim 12, wherein the operations further comprise:
performing receive (Rx) beamsweeping to select a combination of Rx beams.

16. The apparatus of claim 12, wherein the processing circuitry is further configured to:
using a combination of Rx beams and estimating a baseband equivalent channel as a function of the Rx beams.

17. The apparatus of claim 12, wherein the UE comprises a single receive (Rx) antenna panel comprising two physical Rx ports or two receive (Rx) antenna panels each comprising two physical Rx ports.

18. The apparatus of claim 12, wherein the processing circuitry is further configured to:
use a measurement based phase shifting matrix to determine a best analog receive (Rx) beam.

19. The apparatus of claim 12, wherein the processing circuitry is further configured to:
solve for a best receive (Rx) beam for each transmit (Tx) beam pair based on the virtualized effective channel.

20. The apparatus of claim 12, wherein the processing circuitry is further configured to:
perform demodulation over one of the selected beam pairs.
